(19) United States
(12) Patent Application Publication
(10) Pub. No.: US 2014/0019303 A1
(43) Pub. Date: Jan. 16, 2014

(54) Comparison of Product Information

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/549,268

(22) Filed: Jul. 13, 2012

(51) Int. Cl. G06Q 30/00

(52) U.S. Cl. 705/26.64

(57) ABSTRACT

A method for comparison of product information based on product codes to determine the cost per unit volume per product and hereby determine the cheapest product per unit volume is disclosed herein. Embodiments herein enable the consumer to easily access the cost per unit volume of products, without putting an additional burden on the retailer or any other component in the product supply chain.

### BACKGROUND OF THE INVENTION

A product generally comprises at least one label, where the label comprises information about the product such as name of the product, cost of the product, weight of the product and so on. Such labels may contain the information in an alphanumeric format or in the form of a machine-readable code (wherein the code may be a bar code, QR code or any other suitable format). Therefore, when a consumer goes to purchase a product from a retail store, the consumer has to peruse these labels before being able to make an informed decision on his purchase. Consider a scenario where a consumer wants to buy a product, but has to make a selection from two or more products based on cost per unit volume (where the products may be from different sources or from the same sources, but of different sizes). The consumer has to read the labels and perform a mental exercise for estimating the cost per unit volume of the product, before making a decision.

Accordingly, what is needed is an apparatus and method for enabling the consumer to easily access the cost per unit volume of products, without putting an additional burden on the retailer or any other component in the product supply chain.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 depicts a handheld device scanning a label present on a product, according to embodiments as disclosed herein;

FIG. 2 is a schematic block diagram of a handheld device, according to embodiments as disclosed herein;

FIG. 3 is a flowchart depicting the process of determining the cheapest product per unit volume, according to embodiments as disclosed herein;

FIG. 4 depicts a handheld device scanning a label present on a product and taking at least one picture of the product, according to embodiments as disclosed herein;

FIG. 5 is a schematic block diagram of a handheld device, according to embodiments as disclosed herein;

FIG. 6 is a flowchart depicting the process of determining the cheapest product per unit volume, according to embodiments as disclosed herein;

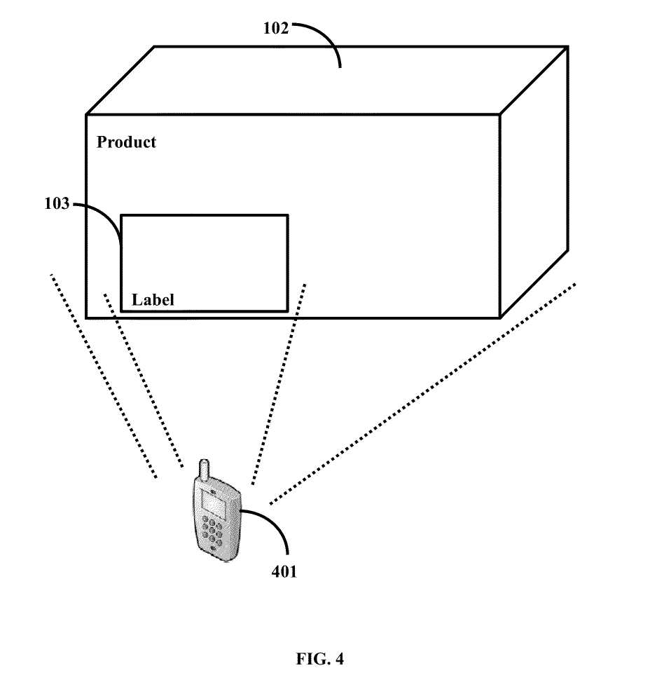

FIG. 4 depicts a handheld device scanning a label present on a product, wherein the handheld device is connected to a computing system, according to embodiments as disclosed herein;

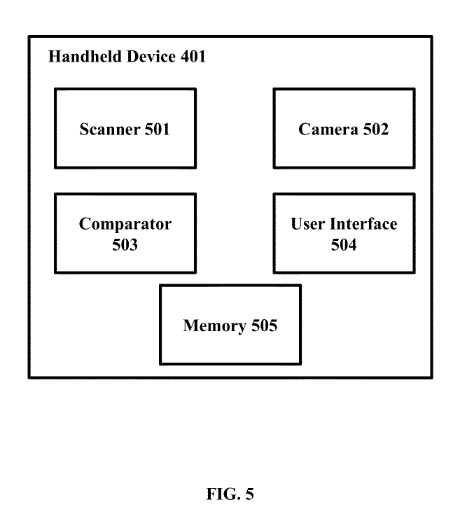

FIG. 5 is a schematic block diagram of a handheld device, according to embodiments as disclosed herein;

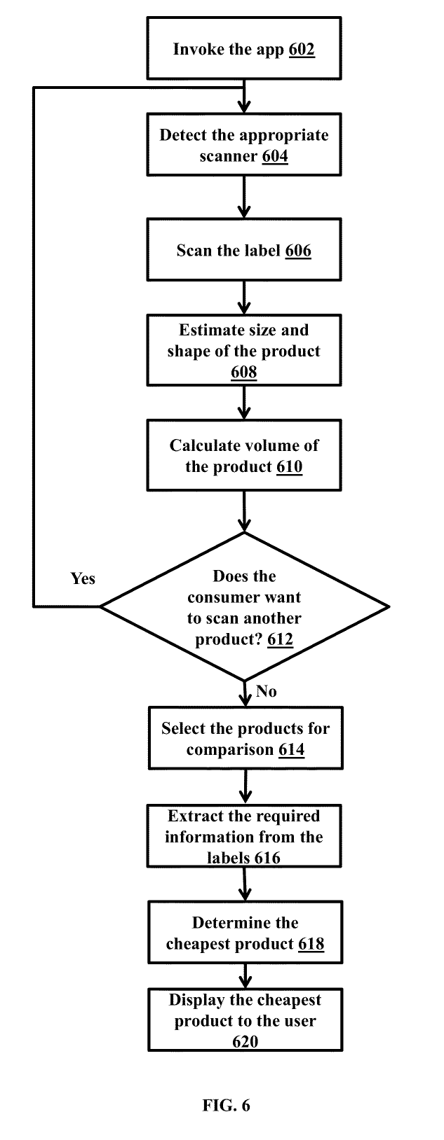

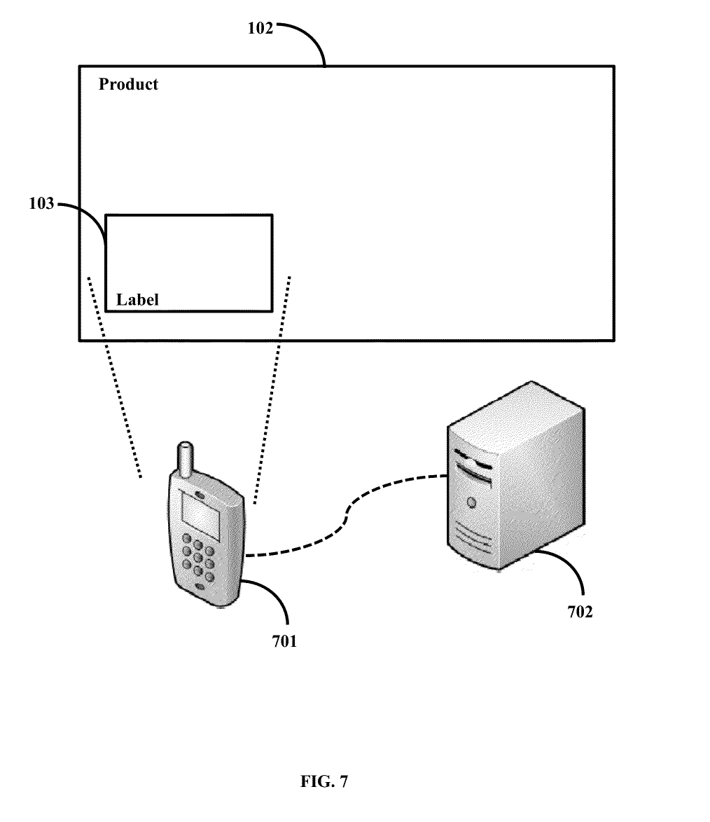

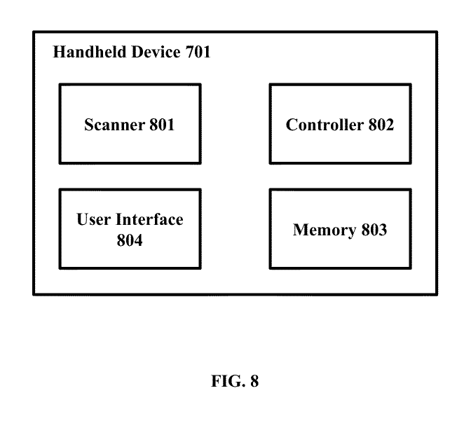

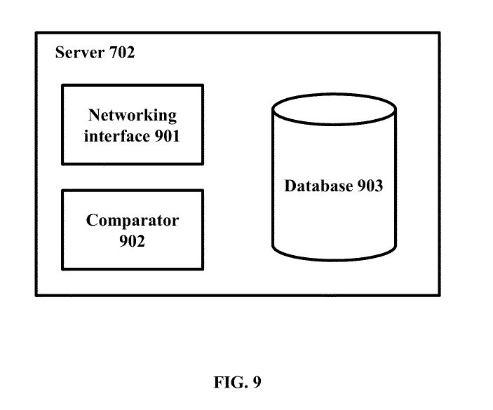

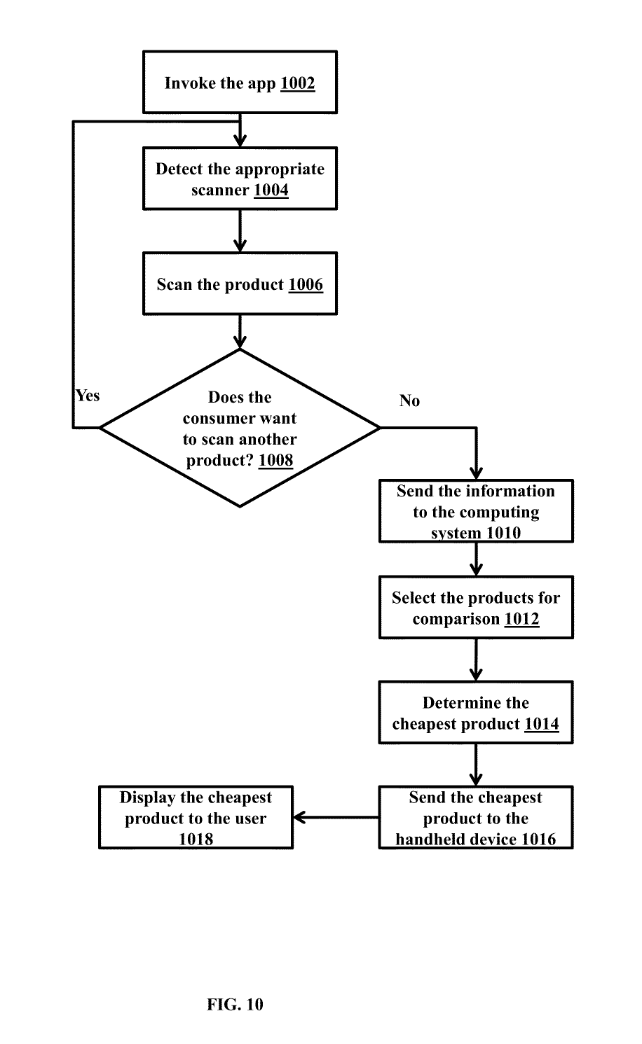

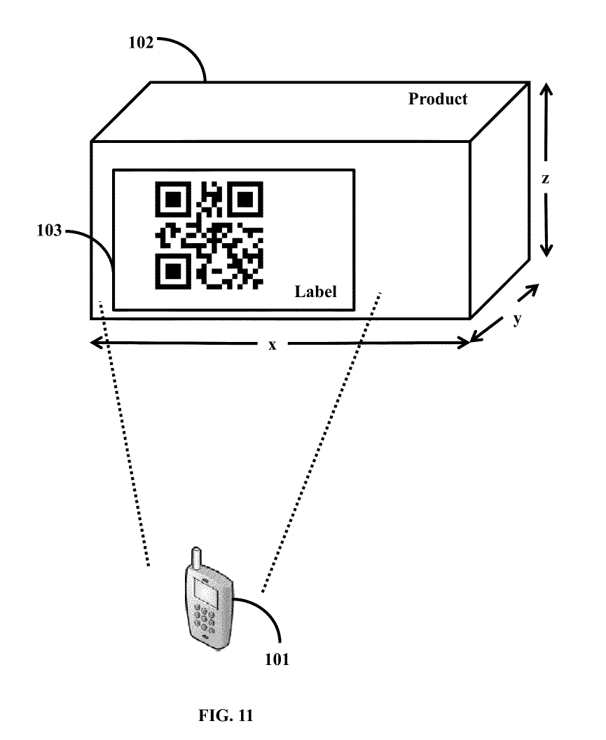

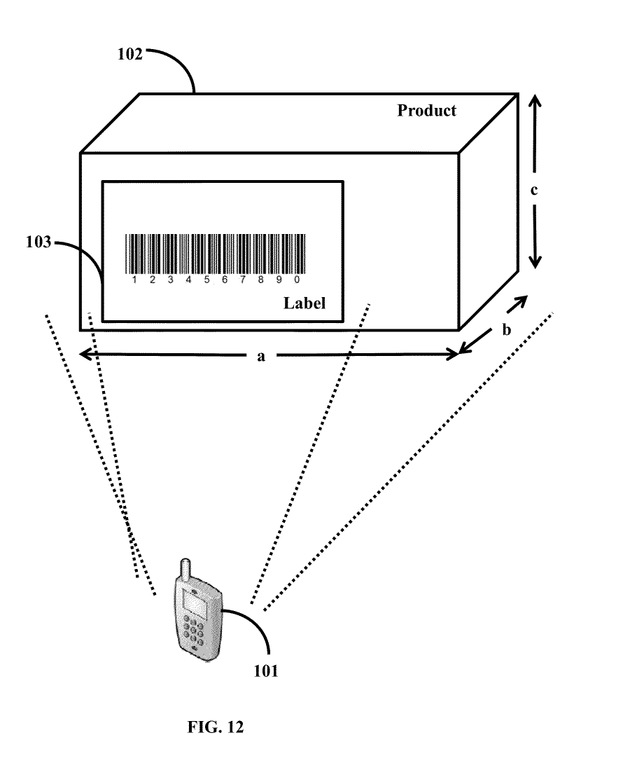

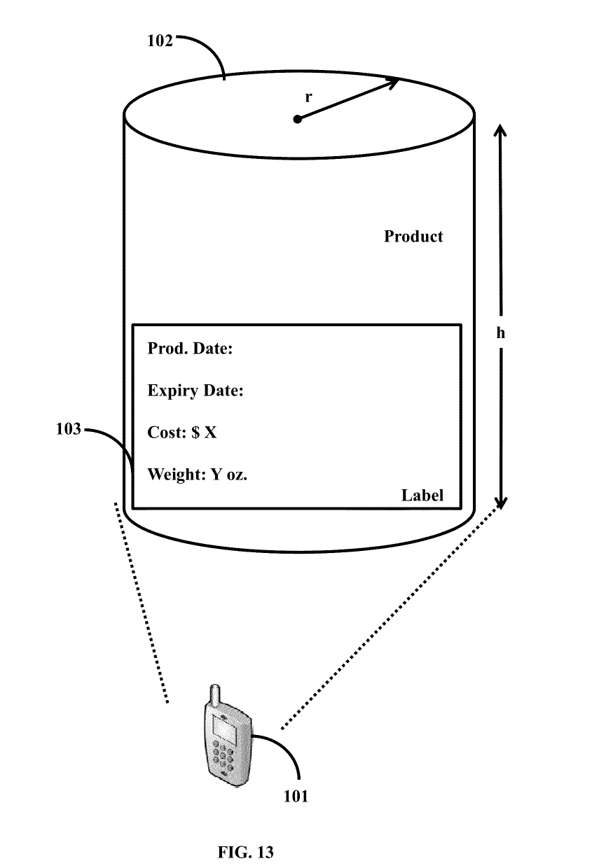

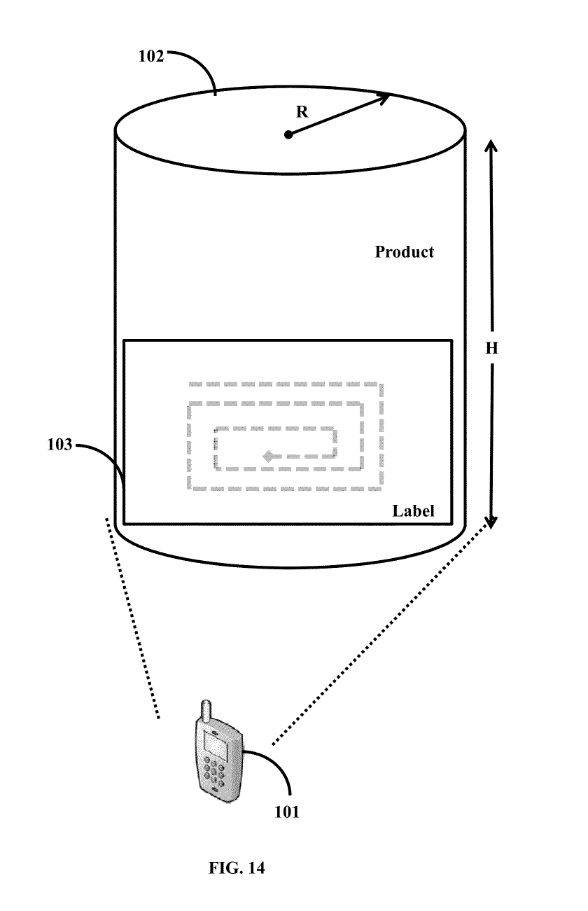

FIG. 6 is a schematic block diagram of a computing system, according to embodiments as disclosed herein;

FIG. 7 is a flowchart depicting the process of determining the cheapest product per unit volume, according to embodiments as disclosed herein;

FIG. 8 depicts a handheld device scanning a label comprising a QR code, according to embodiments as disclosed herein;

FIG. 9 depicts a handheld device scanning a label comprising a barcode, according to embodiments as disclosed herein;

FIG. 10 is a handheld device scanning a label with textual information, according to embodiments as disclosed herein; and

FIG. 11 depicts a handheld device scanning a label with a RFID tag, according to embodiments as disclosed herein.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for enabling the consumer to easily access the cost per unit volume of products.

Herein, the consumer may scan a first label on a first product using a handheld device. In certain embodiments, the label may contain alphanumeric data, wherein the data may be a listing of price of the product, weight of the product, expiry date of the product, date of manufacture of the product and so on. In certain embodiments, the label may contain at least one machine-readable code, wherein the machine-readable code may be a two-dimensional barcode (e.g., a linear barcode, a Quick Response (QR) Code, a DataMatrix code). In selected embodiments, a machine-readable code may encode a product identification number uniquely identifying the product, cost of the product, price of the product, weight of the product and so on. In other embodiments herein, the label may be wireless proximity based tag (such as a Radio Frequency Identification (RFID) tag). The data present on the label may vary between different embodiments and different purposes or goals of the label.

The handheld device, as disclosed herein, may be a mobile phone, a Personal Digital Assistant (PDA), a tablet, a portable multimedia player, a handheld computing device or a dedicated scanning device. The scanned first label may be compared with a second label to obtain a comparison of the price per unit volume of the product with the scanned label with the price per unit volume of the second product, wherein the second label belongs to the second product. The total volume of the products being scanned may be obtained from a suitable location within the handheld device, from a remote location or from a combination of the suitable location within the handheld device and the remote location. In certain embodiments herein, the second label may be scanned by the handheld device in real time. In other embodiments herein, the second label may be scanned by the device at a previous point in time and stored in a suitable location, wherein the second label may be retrieved from the location as required. The handheld device further gives an indication to the consumer of the cheaper product per unit volume, on basis of the comparison between the price per unit volumes as indicated by the first label and the second label.

Embodiments herein discuss comparison of first label and a second label merely for the purposes of illustration, but it may be obvious to a person to extend the comparison to any number of labels, wherein the labels may be scanned in real time or retrieved from a storage location.

In general, the purpose of various embodiments disclosed herein may be to benefit, economically or otherwise, a consumer, an entity (e.g., an entity issuing the receipt, the retailing entity, the manufacturing/packaging entity), or some combination thereof.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. Further, the computer programming code may be written using a development tool available for developing apps, where apps refer to software applications that are used in personal devices such as smart phones and other devices. The program code may execute entirely on the handheld device, a remote computing system or server (herein after referred to as the computing system) or partly on the computing system and the handheld device. In the latter scenario, the computing system may be connected to the handheld device through a suitable type of communication network, such as a cellular communication network, a wireless communication network and so on.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

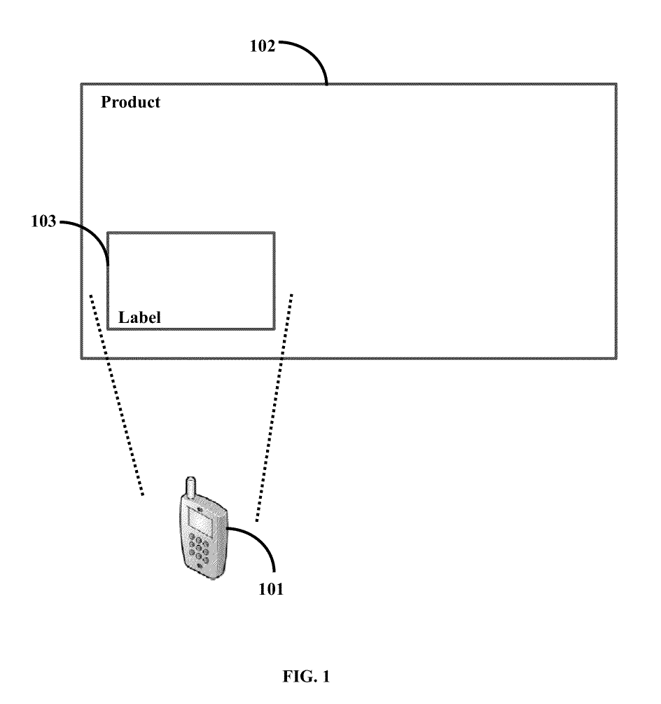

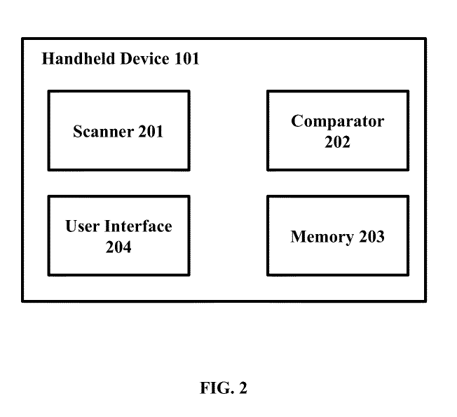

FIG. 1 depicts a handheld device 101 scanning a label 103 present on a product 102. The label 103 may be an alphanumeric data based label, a machine-readable data based label or a RFID based label. The handheld device 101 may be any suitable device capable of reading the label 103. Examples of the handheld device 101 may be a mobile phone, a PDA, a tablet, a handheld scanner or a dedicated scanning device. The handheld device 101 may comprise of more than one type of scanner, wherein the scanner used for reading a particular label depends on the type of label being scanned. The handheld device 101 comprises an application, wherein the application performs the functions as detailed herein. The handheld device 101 may be brought by the consumer into the retail location. In certain embodiments, the handheld device 101 may be provided to the consumer by the retailer for use at the retail location.

Consider an example, where the label 103 is an alphanumeric data based label, the handheld device 101 comprises a camera to capture to data printed on the label 103. In a second example, the handheld device 101 comprises of a scanner (such as a camera, laser scanner and so on) which the consumer uses to scan the label containing a machine-readable code (such as a barcode, QR code and so on). In a third example, the handheld device 101 uses a RFID reader to read the RFID label 103 present on the product 102.

The handheld device 101 may scan the label using an app stored within the handheld device 101 upon being initiated by a user. The app may be an application present on the phone, wherein the app may be initiated by the consumer using a suitable interface.

In an embodiment herein, the app on the handheld device 101 may fetch information related to the product 102 being scanned. The information may comprise of size of the product (in terms of height, length and width of the product, radius of the product and so on), shape of the product and so on. The app calculates the volume of the product being scanned from the fetched information. The app may fetch the information from a memory present within the handheld device 101. In another embodiment herein, the app may fetch the information from a remote location, such as a server belonging to the retailer, a cloud service and so on. In another embodiment herein, the app may fetch the volume of the product 102 being scanned. The app compares the information related to the product 102 with the scanned label with at least one other product, wherein labels of the other products may be scanned at a later point by the handheld device 101.

In another embodiment herein, the app on the handheld device 101 compares the information related to the product 102 with the scanned label with at least one other product, wherein the other labels may be stored in a memory associated with the handheld device 101.

In another embodiment herein, the app on the handheld device 101 compares the information related to the product 102 with the scanned label with at least one other product, wherein at least one of the other labels may be stored in a memory associated with the handheld device 101 and other labels may be scanned at a later point by the handheld device 101.

The app on the handheld device 101 extracts the required information from the labels. The extracted information may comprise of cost of the product and so on. The app computes the cost per unit volume for each of the products to whom the label belongs. The app further compares the cost per unit volume for all of the products to whom the label belongs and determines the cheapest product (wherein the cheapest product is the product with lowest cost per unit volume).

In an embodiment herein, the app may standardize the unit volumes, in case the volume or the sizes of the product are mentioned in different units. The app may standardize the units of the volume to a default unit or as specified by the consumer.

The handheld device 101 may further display the cheapest product to the consumer. In certain embodiments herein, the handheld device 101 may display a list comprising of all compared products, wherein the list may be arranged in ascending order from the cheapest product to the most expensive product. The consumer may also be offered the option of re-ordering the list, as per his preferences. The consumer may also be offered the option of changing the units of the volume being displayed to another suitable unit.

Referring to FIG. 2, which depicts a handheld device, according to embodiments as disclosed herein. The handheld device 101, as depicted, comprises of a scanner 201, a comparator 202, a memory 203 and a user interface 204, in accordance with the present invention.

The scanner 201 may comprise of at least one type of scanning means. The scanning means may be a camera incorporated into the device, a RFID reader, a barcode reader (such as a laser scanner) and so on.

The comparator 202 may be an app residing on the handheld device 101, wherein the comparator 202 may be invoked by the consumer using the user interface 204. The user interface 204 may be at least one of a visual display (such as a display screen and so on), a touch based input means (such as a keyboard, a touch screen interface and so on), an audio means (such as a speaker and so on) and so on. The comparator 202, on being invoked, performs a check for the type of label 103 to be scanned. In certain embodiments herein, the check for the type of label 103 to be scanned may be done using a camera present on the handheld device 101, wherein the consumer may be instructed to point the camera at the label 103. In other embodiments herein, the comparator 202 instructs the consumer to input the type of label 103 to be scanned, wherein the consumer may be instructed using the user interface 204. The consumer may be instructed to select from a list of labels which are supported by the handheld device 101. In an alternative, the consumer may be instructed to enter the type of label 103 to be scanned, wherein an auto-completion or suggestion feature may be incorporated. Based on the type of label 103, the comparator 202 invokes the specific scanner required to scan the label 103. If more than one type of scanner may be used to scan the label 103, the comparator 202 may check for user preferences for the scanner to be used. the comparator 202 may also check based on the past scanning history, as to which scanner has been used more frequently and which scanner gives better results, in terms of better clarity of scans, time required for scanning and so on. Consider an example, where a barcode on a label has to be scanned. The barcode may be scanned using a camera (as done in mobile devices) or by a dedicated laser scanner (as done at the checkout counters at retail outlets), both of which are present in the handheld device 101. The comparator 202 selects the laser scanner, as the consumer has indicated that he wants to scan the label 103 using the laser scanner.

The comparator 202 invokes the required scanner 201. The consumer may be instructed to point the scanning device in the direction of the label 103, using the user interface 204. The consumer may be given directions as to the proper manner and direction in which the handheld device 101 has to be oriented. On detecting that the handheld device 101 has been oriented in the proper direction, the scanner 201 scans the label 103. The handheld device 101 may use a suitable means such as a combination of a camera, an accelerometer and so on to detect the current orientation of the handheld device 101.

On receiving the scanned label, the comparator 202 checks if the consumer wants to scan another label using the user interface 204. The comparator 202 may store the scanned label in the memory 203 (wherein the memory 203 may comprise of one or more memory modules). In certain embodiments herein, the memory 201 may be present external to the handheld device 101, wherein the handheld device 101 communicates with the memory 203 using a suitable communication means.

If the consumer wants to scan another label, then the consumer selects the appropriate selection using the user interface 204. On receiving the input from the consumer, the comparator 202 performs the steps as disclosed above to scan a second label.

If the consumer does not want to scan another label, the comparator 202 may ask the consumer to select at least two products for comparison using the user interface 204. The user interface 204 may offer a list of scanned labels corresponding to the products, wherein the consumer may select two or more products from the list for the comparison. At least one of the products may have been scanned by the handheld device 101 in real time. In certain embodiments, at least one of the products may be retrieved from the memory 203.

The comparator 202 extracts the required information from the labels corresponding to the selected products. The extracted information may comprise of cost of the product and so on. The comparator 202 further fetches information related to the products whose labels have to be compared. The information may comprise of size of the product (in terms of height, length and width of the product, radius of shape of product and so on), shape of the product and so on. The comparator 202 calculates the volume of the product being scanned from the fetched information. The comparator 202 may fetch the information from the memory 203. In another embodiment herein, the comparator 202 may fetch the information from a remote location, such as a server belonging to the retailer, a cloud service and so on. In another embodiment herein, the comparator 202 may directly fetch the volume of the product 102 being scanned. The comparator 202 computes the cost per unit volume for each of the products to whom the label belongs. The comparator 202 further compares the cost per unit volume for all of the products to whom the label belongs and determines the cheapest product (wherein the cheapest product is the product with lowest cost per unit volume).

In an embodiment herein, the comparator 202 may standardize the unit volumes, in case the volume or the sizes of the product are mentioned in different units. The comparator 202 may standardize the units of the volume to a default unit or as specified by the consumer.

The comparator 202 may further display the cheapest product to the consumer using the user interface 204. In certain embodiments herein, the user interface 204 may display a list comprising of all compared products, wherein the comparator 202 may arrange the list in ascending order from the cheapest product to the most expensive product. The user interface 204 may also offer the option of re-ordering the list to the consumer, as per his preferences. The consumer may also be offered the option of changing the units of the volume being displayed to another suitable unit.

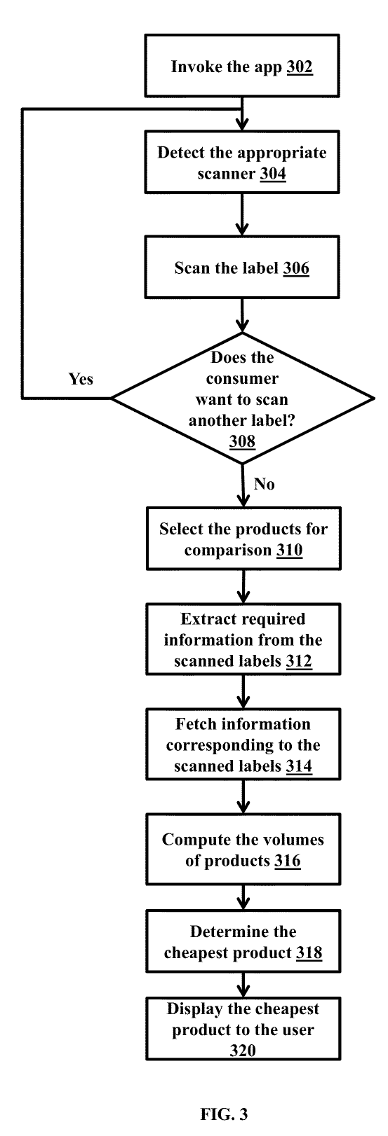

FIG. 3 is a flowchart depicting the process of determining the cheapest product per unit volume, according to embodiments as disclosed herein. The consumer invokes 302 the app residing on the handheld device 101. The app, on being invoked, determines 304 the type of label 103 to be scanned. In certain embodiments herein, the check for the type of label 103 to be scanned may be done using a camera present on the handheld device 101, wherein the consumer may be instructed to point the camera at the label 103. In other embodiments herein, the app instructs the consumer to input the type of label 103 to be scanned. The consumer may be instructed to select from a list of labels which are supported by the handheld device 101. In an alternative, the consumer may be instructed to enter the type of label 103 to be scanned, wherein an auto-completion or suggestion feature may be incorporated. If more than one type of scanner may be used to scan the label 103, the app may check for user preferences for the scanner to be used. The app may also check based on the past scanning history, as to which scanner has been used more frequently and which scanner gives better results, in terms of better clarity of scans, time required for scanning and so on. Based on the type of label, the app scans 306 the label 103. The app may ask the consumer to point the scanning device in the direction of the label 103. The consumer may be given directions as to the proper manner in which the handheld device 101 has to be oriented. The handheld device 101 may use a suitable means such as a combination of a camera, an accelerometer and so on to detect the current orientation of the handheld device 101. On receiving the scanned label, the app checks 308 if the consumer wants to scan another label. The app may store the scanned label. If the consumer wants to scan another label, then the app performs the steps as disclosed above to scan a second label. If the consumer does not want to scan another label, the consumer selects 310 at least two products for comparison. The app may offer a list of scanned labels and products, wherein the consumer may select two or more products from the list for the comparison. At least one of the products may have been scanned by the handheld device 101 in real time. In certain embodiments, at least one of the products may be retrieved from the memory 203. The app extracts 312 the required information from the selected labels. The extracted information may comprise of cost of the product and so on. The app further fetches 314 the required information for the products to be compared, such as size of the products (in terms of height, length and width of the product, radius of shape of product and so on), shape of the product and so on and determines 316 the volume of the product 102. The app determines 318 the cheapest product (wherein the cheapest product is the product with lowest cost per unit volume) by computing the cost per unit volume for each of the products to whom the label belongs and comparing the cost per unit volume for all of the products to whom the label belongs and determines the cheapest product. The app displays 320 the cheapest product to the consumer. In certain embodiments herein, the app may display a list comprising of all compared products, wherein the app may arrange the list in ascending order from the cheapest product to the most expensive product. The app may also offer the option of re-ordering the list to the consumer, as per his preferences. The consumer may also be offered the option of changing the units of the volume being displayed to another suitable unit.

FIG. 4 depicts a handheld device 401 scanning a label 103 present on a product 102. The label 103 may be an alphanumeric data based label, a machine-readable data based label or a RFID based label. The handheld device 401 may be any suitable device capable of reading the label 103. Examples of the handheld device 401 may be a mobile phone, a PDA, a tablet, a handheld scanner or a dedicated scanning device. The handheld device 401 may comprise of more than one type of scanner, wherein the scanner used for reading a particular label depends on the type of label being scanned. The handheld device 401 comprises an application, wherein the application performs the functions as detailed herein. The handheld device 401 may be brought by the consumer into the retail location. In certain embodiments, the handheld device 401 may be provided to the consumer by the retailer for use at the retail location.

Consider an example, where the label 103 is an alphanumeric data based label, the handheld device 401 comprises a camera to capture to data printed on the label 103. In a second example, the handheld device 401 comprises of a scanner (such as a camera, laser scanner and so on) which the consumer uses to scan the label containing a machine-readable code (such as a barcode, QR code and so on). In a third example, the handheld device 401 uses a RFID reader to read the RFID label 103 present on the product 102.

The handheld device 401 may scan the label on an app within the handheld device 401 being initiated. The app may be an application present on the phone, wherein the app may be initiated by the consumer using a suitable interface.

The handheld device 401 further captures the size and shape of the product. The app may instruct the consumer to use the camera to take pictures of the product at various angles, wherein the app may instruct the consumer as to the specific angles required to be used for taking the pictures. In another embodiment herein, the handheld device 401 may comprise of a 3-dimensional (3D) camera system, wherein the app may instruct the consumer to take a picture of the product from a specific angle. The app determines the type of shape of the product from the inputs received from the camera. In another embodiment herein, the handheld device 101 comprises of a 3D scanner, which is capable of scanning a device in multiple dimensions. The 3D scanner is used to scan the product and the scanner output is used to determine the size and shape of the product. For example, the shape of the product may be rectangular, spherical, cylindrical, rhomboid and so on. The app further determines the size of the product from the inputs received from the camera. For example, the size of the product may be determined in terms of height, length and width of the product, if the product is rectangular. In another example, the size of the product may be determined in terms of radius of the product, if the product is spherical in shape.

The app calculates the volume of the product based on the shape of the product and the size of the product. The app compares the information related to the product 102 with the scanned label with at least one other product, wherein labels of the other products may be scanned at a later point by the handheld device 401.

In another embodiment herein, the app on the handheld device 401 compares the information related to the product 102 with the scanned label with at least one other product, wherein the other labels may be stored in a memory associated with the handheld device 401.

In another embodiment herein, the app on the handheld device 401 compares the information related to the product 102 with the scanned label with at least one other product, wherein at least one of the other labels may be stored in a memory associated with the handheld device 401 and other labels may be scanned at a later point by the handheld device 401.

The app on the handheld device 401 extracts the required information from the labels. The extracted information may comprise of cost of the product and so on. The app computes the cost per unit volume for each of the products to whom the label belongs. The app further compares the cost per unit volume for all of the products to whom the label belongs and determines the cheapest product (wherein the cheapest product is the product with lowest cost per unit volume).

In an embodiment herein, the app may standardize the unit volumes, in case the volume or the sizes of the product are mentioned in different units. The app may standardize the units of the volume to a default unit or as specified by the consumer.

The handheld device 401 may further display the cheapest product to the consumer. In certain embodiments herein, the handheld device 401 may display a list comprising of all compared products, wherein the list may be arranged in ascending order from the cheapest product to the most expensive product. The consumer may also be offered the option of re-ordering the list, as per his preferences. The consumer may also be offered the option of changing the units of the volume being displayed to another suitable unit.

Referring to FIG. 5, which depicts a handheld device, according to embodiments as disclosed herein. The handheld device 401, as depicted, comprises of a scanner 501, a camera system 502, a comparator 503 a user interface 504 and a memory 505, in accordance with the present invention.

The scanner 501 may comprise of at least one type of scanning means. The scanning means may be a camera incorporated into the device, a RFID reader, a barcode reader (such as a laser scanner) and so on.

The comparator 503 may be an app residing on the handheld device 401, wherein the comparator 503 may be invoked by the consumer using the user interface 504. The user interface 504 may be at least one of a visual display (such as a display screen and so on), a touch based input means (such as a keyboard, a touch screen interface and so on), an audio means (such as a speaker and so on) and so on. The comparator 503, on being invoked, performs a check for the type of label 103 to be scanned. In certain embodiments herein, the check for the type of label 103 to be scanned may be done using a camera present on the handheld device 401, wherein the consumer may be instructed to point the camera at the label 103. In other embodiments herein, the comparator 503 instructs the consumer to input the type of label 103 to be scanned, wherein the consumer may be instructed using the user interface 504. The consumer may be instructed to select from a list of labels which are supported by the handheld device 401. In an alternative, the consumer may be instructed to enter the type of label 103 to be scanned, wherein an auto-completion or suggestion feature may be incorporated. Based on the type of label 103, the comparator 503 invokes the specific scanner required to scan the label 103. If more than one type of scanner may be used to scan the label 103, the comparator 503 may check for user preferences for the scanner to be used. the comparator 503 may also check based on the past scanning history, as to which scanner has been used more frequently and which scanner gives better results, in terms of better clarity of scans, time required for scanning and so on. Consider an example, where a barcode on a label has to be scanned. The barcode may be scanned using a camera (as done in mobile devices) or by a dedicated laser scanner (as done at the checkout counters at retail outlets), both of which are present in the handheld device 401. The comparator 503 selects the laser scanner, as the consumer has indicated that he wants to scan the label 103 using the laser scanner.

The comparator 503 invokes the required scanner 501. The consumer may be instructed to point the scanning device in the direction of the label 103, using the user interface 504. The consumer may be given directions as to the proper manner and direction in which the handheld device 401 has to be oriented. On detecting that the handheld device 401 has been oriented in the proper direction, the scanner 501 scans the label 103. The handheld device 401 may use a suitable means such as a combination of a camera, an accelerometer and so on to detect the current orientation of the handheld device 401.

On receiving the scanned label, the comparator 503 checks if the consumer wants to scan another label using the user interface 504. The comparator 503 may store the scanned label in the memory 505 (wherein the memory 505 may comprise of one or more memory modules). In certain embodiments herein, the memory 501 may be present external to the handheld device 401, wherein the handheld device 401 communicates with the memory 505 using a suitable communication means.

The comparator 503 further captures the size and shape of the product. The comparator 503 may instruct the consumer to use the camera system 502 to take pictures of the product at various angles, wherein the app may instruct the consumer as to the specific angles required to be used for taking the pictures. In another embodiment herein, the camera system 502 may be a 3-dimensional (3D) camera system, wherein the comparator 503 may instruct the consumer to take a picture of the product 102 from a specific angle. The comparator 503 determines the type of shape of the product from the inputs received from the camera system 502. In another embodiment herein, the handheld device 101 comprises of a 3D scanner and the handheld device 101 captures the size and shape of the product using the 3D scanner. For example, the shape of the product may be rectangular, spherical, cylindrical, rhomboid and so on. The comparator 503 further determines the size of the product from the inputs received from the camera system 502. For example, the size of the product may be determined in terms of height, length and width of the product, if the product is rectangular. In another example, the size of the product may be determined in terms of radius of the product, if the product is spherical in shape. The comparator 503 calculates the volume of the product based on the shape of the product and the size of the product 102. The comparator may store the calculated volume in the memory 505.

If the consumer wants to scan another label, then the consumer selects the appropriate selection using the user interface 504. On receiving the input from the consumer, the comparator 503 performs the steps as disclosed above to scan a second label.

If the consumer does not want to scan another label, the comparator 503 may ask the consumer to select at least two products for comparison using the user interface 504. The user interface 504 may offer a list of scanned labels corresponding to the products, wherein the consumer may select two or more products from the list for the comparison. At least one of the products may have been scanned by the handheld device 401 in real time. In certain embodiments, at least one of the products may be retrieved from the memory 505.

The comparator 503 extracts the required information from the labels corresponding to the selected products. The extracted information may comprise of cost of the product and so on. The comparator 503 computes the cost per unit volume for each of the products to whom the label belongs. The comparator 503 further compares the cost per unit volume for all of the products to whom the label belongs and determines the cheapest product (wherein the cheapest product is the product with lowest cost per unit volume).

In an embodiment herein, the comparator 503 may standardize the unit volumes, in case the volume or the sizes of the product are mentioned in different units. The comparator 503 may standardize the units of the volume to a default unit or as specified by the consumer.

The comparator 503 may further display the cheapest product to the consumer using the user interface 504. In certain embodiments herein, the user interface 504 may display a list comprising of all compared products, wherein the comparator 503 may arrange the list in ascending order from the cheapest product to the most expensive product. The user interface 504 may also offer the option of re-ordering the list to the consumer, as per his preferences. The consumer may also be offered the option of changing the units of the volume being displayed to another suitable unit.

FIG. 6 is a flowchart depicting the process of determining the cheapest product per unit volume, according to embodiments as disclosed herein. The consumer invokes 602 the app residing on the handheld device 401. The app, on being invoked, determines 604 the type of label 103 to be scanned. In certain embodiments herein, the check for the type of label 103 to be scanned may be done using a camera present on the handheld device 401, wherein the consumer may be instructed to point the camera at the label 103. In other embodiments herein, the app instructs the consumer to input the type of label 103 to be scanned. The consumer may be instructed to select from a list of labels which are supported by the handheld device 401. In an alternative, the consumer may be instructed to enter the type of label 103 to be scanned, wherein an auto-completion or suggestion feature may be incorporated. If more than one type of scanner may be used to scan the label 103, the app may check for user preferences for the scanner to be used. The app may also check based on the past scanning history, as to which scanner has been used more frequently and which scanner gives better results, in terms of better clarity of scans, time required for scanning and so on. Based on the type of label, the app scans 606 the label 103. The app may ask the consumer to point the scanning device in the direction of the label 103. The consumer may be given directions as to the proper manner in which the handheld device 401 has to be oriented. The handheld device 401 may use a suitable means such as a combination of a camera, an accelerometer and so on to detect the current orientation of the handheld device 401. Further, the handheld device 401 determines 608 the shape and size of the product 102. The handheld device 401 may determine the shape and size of the product 102 using a camera system, wherein the app may instruct the consumer to use the camera system to take pictures of the product at various angles, wherein the app may instruct the consumer as to the specific angles required to be used for taking the pictures. In another embodiment herein, the camera system may be a 3-dimensional (3D) camera system, wherein the app may instruct the consumer to take a picture of the product 102 from a specific angle. The app determines the type of shape of the product from the inputs received from the camera system. The app further determines the size of the product from the inputs received from the camera system. In another embodiment herein, the app determines the size and shape of the product using the 3D scanner. The handheld device 401 calculates 610 the volume of the product based on the shape of the product and the size of the product. On receiving the above information, the app checks 612 if the consumer wants to scan another label. The app may store the scanned label. If the consumer wants to scan another label, then the app performs the steps as disclosed above to scan a second label. If the consumer does not want to scan another label, the consumer selects 614 at least two products for comparison. The app may offer a list of scanned labels and products, wherein the consumer may select two or more products from the list for the comparison. At least one of the products may have been scanned by the handheld device 401 in real time. In certain embodiments, at least one of the products may be retrieved from the memory 505. The app extracts 616 the required information from the selected labels. The extracted information may comprise of cost of the product and so on. The app determines 618 the cheapest product (wherein the cheapest product is the product with lowest cost per unit volume) by computing the cost per unit volume for each of the products to whom the label belongs and comparing the cost per unit volume for all of the products to whom the label belongs and determines the cheapest product. The app displays 620 the cheapest product to the consumer. In certain embodiments herein, the app may display a list comprising of all compared products, wherein the app may arrange the list in ascending order from the cheapest product to the most expensive product. The app may also be offer the option of re-ordering the list to the consumer, as per his preferences. The consumer may also be offered the option of changing the units of the volume being displayed to another suitable unit.

In another embodiment herein, the app may calculate the volume of the selected products in real time, after the consumer has selected the products.

FIG. 7 depicts a handheld device 701 scanning a label 103 present on a product 102, wherein the handheld device 701 is connected to a computing system 702. The label 103 may be an alphanumeric data based label, a machine-readable data based label or a RFID based label. The handheld device 701 may be any suitable device capable of reading the label 103. Examples of the handheld device 701 may be a mobile phone, a PDA, a tablet, a handheld scanner or a dedicated scanning device. The handheld device 701 may comprise of more than one type of scanner, wherein the scanner used for reading a particular label depends on the type of label being scanned. The handheld device 701 comprises an application, wherein the application performs the functions as detailed herein. The handheld device 701 may be brought by the consumer into the retail location. In certain embodiments, the handheld device 701 may be provided to the consumer by the retailer for use at the retail location. The handheld device 701 may be connected to the computing system 702 using a suitable wireless communication link, such as a Wi-Fi network, a cellular communication network, a short range communication network (such as Bluetooth, Sigsbee and so on). The computing system 702 may comprise of at least one computing system, which may comprise of a server, a desktop computer, a portable computer, a dedicated device and so on.

Consider an example, where the label 103 is an alphanumeric data based label, the handheld device 701 comprises a camera to capture to data printed on the label 103. In a second example, the handheld device 701 comprises of a scanner (such as a camera, laser scanner and so on) which the consumer uses to scan the label containing a machine-readable code (such as a barcode, QR code and so on). In a third example, the handheld device 701 uses a RFID reader to read the RFID label 103 present on the product 102.

The handheld device 701 may scan the label, on an app within the handheld device 701 being initiated. The app may be an application present on the phone, wherein the app may be initiated by the consumer using a suitable interface.

In an embodiment herein, the app on the handheld device 701 scans the label 103 and sends the scanned label to the computing system 702. The computing system 702 identifies the product corresponding to the scanned label 103 and fetches information related to the product 102 being scanned. The information may comprise of size of the product (in terms of height, length and width of the product, radius of shape of product and so on), shape of the product and so on. The computing system 702 calculates the volume of the product being scanned from the fetched information. The computing system 702 may fetch the information from a memory present within the computing system 702. In another embodiment herein, the computing system 702 may fetch the information from a remote location, such as a server belonging to the retailer, a cloud service and so on. In another embodiment herein, the computing system 702 may fetch the volume of the product 102 being scanned. The computing system 702 may store the calculated volume in a suitable storage location.

The computing system 702 compares the information related to the scanned product with at least one other product, wherein the other product may be scanned at a later point by the handheld device 701.

In another embodiment herein, the app on the handheld device 701 scans the label 103 and sends the scanned label to the computing system 702. The computing system 702 compares the information related to the scanned product with at least one other product, wherein the other product may be stored in a memory associated with the handheld device 701.

In another embodiment herein, the computing system 702 compares the information related to the scanned product with at least one other product, wherein the other product may be stored in a memory associated with the computing system 702 or the handheld device 701 and other labels may be scanned at a later point by the handheld device 701.

The computing system 702 extracts the required information from the labels. The extracted information may comprise of cost of the product and so on. The computing system 702 computes the cost per unit volume for each of the products to whom the label belongs. The computing system 702 further compares the cost per unit volume for all of the products to whom the label belongs and determines the cheapest product (wherein the cheapest product is the product with lowest cost per unit volume). In another embodiment herein, the computing system 702 may provide labels which may have been stored by other consumers to the current consumer for comparison.

In an embodiment herein, the computing system 702 may standardize the unit volumes, in case the volume or the sizes of the product are mentioned in different units. The computing system 702 may standardize the units of the volume to a default unit or as specified by the consumer.

The computing system 702 sends the information to the handheld device 701. The information may comprise of the cheapest product, the cost per unit volume of the cheapest product, a list of all the products which have been compared and corresponding costs per unit volume of the products. The handheld device 701 may further display the cheapest product to the consumer. In certain embodiments herein, the handheld device 701 may display a list comprising of all compared products, wherein the list may be arranged in ascending order from the cheapest product to the most expensive product. The consumer may also offer the option of re-ordering the list, as per his preferences. The consumer may also be offered the option of changing the units of the volume being displayed to another suitable unit.

Referring to FIG. 8, which depicts a handheld device, according to embodiments as disclosed herein. The handheld device 701, as depicted, comprises of a scanner 801, a controller 802, a memory 803 and a user interface 804, in accordance with the present invention.

The scanner 801 may comprise of at least one type of scanning means. The scanning means may be a camera incorporated into the device, a RFID reader, a barcode reader (such as a laser scanner) and so on.

The controller 802 may be an app residing on the handheld device 701, wherein the controller 802 may be invoked by the consumer using the user interface 804. The user interface 801 may be at least one of a visual display (such as a display screen and so on), a touch based input means (such as a keyboard, a touch screen interface and so on), an audio means (such as a speaker and so on) and so on. The controller 802, on being invoked, performs a check for the type of label 103 to be scanned. In certain embodiments herein, the check for the type of label 103 to be scanned may be done using a camera present on the handheld device 701, wherein the consumer may be instructed to point the camera at the label 103. In other embodiments herein, the controller 802 instructs the consumer to input the type of label 103 to be scanned, wherein the consumer may be instructed using the user interface 804. The consumer may be instructed to select from a list of labels which are supported by the handheld device 701. In an alternative, the consumer may be instructed to enter the type of label 103 to be scanned, wherein an auto-completion or suggestion feature may be incorporated. Based on the type of the label 103, the controller 802 invokes the specific scanner required to scan the label 103. If more than one type of scanner may be used to scan the label 103, the controller 802 may check for user preferences for the scanner to be used. the controller 802 may also check based on the past scanning history, as to which scanner has been used more frequently and which scanner gives better results, in terms of better clarity of scans, time required for scanning and so on. Consider an example, where a barcode on a label has to be scanned. The barcode may be scanned using a camera (as done in mobile devices) or by a dedicated laser scanner (as done at the checkout counters at retail outlets), both of which are present in the handheld device 701. The controller 802 selects the laser scanner, as the consumer has indicated that he wants to scan the label 103 using the laser scanner.

The controller 802 invokes the required scanner 801. The consumer may be instructed to point the scanning device in the direction of the label 103, using the user interface 804. The consumer may be given directions as to the proper manner in which the handheld device 701 has to be oriented. On detecting that the handheld device 701 has been oriented in the proper direction, the scanner 801 scans the label 103. The handheld device 701 may use a suitable means such as a combination of a camera, an accelerometer and so on to detect the current orientation of the handheld device 701.

On receiving the scanned label, the controller 802 checks if the consumer wants to scan another label using the user interface 804, before proceeding with sending the scanned label to the computing system 702.

If the consumer wants to scan another label, then the consumer selects the appropriate selection using the user interface 804. On receiving the input from the consumer, the controller 802 performs the steps as disclosed above to scan a second label.

If the consumer does not want to scan another label, the controller 802 may instruct the consumer to select at least one label for comparison using the user interface 804, as per instructions received from the computing system 702. The user interface 804 may offer a list of scanned labels, wherein the consumer may select two or more labels from the list for the comparison. At least one of the labels may have been scanned by the handheld device 701 in real time. In certain embodiments, at least one of the labels may be retrieved from the memory 803.

In an embodiment herein, the controller 802 may standardize the unit volumes, in case the volume or the sizes of the product are mentioned in different units. The controller 802 may standardize the units of the volume to a default unit or as specified by the consumer.

The controller 802 may further display the cheapest product to the consumer using the user interface 804, on receiving the information from the computing system 702. In certain embodiments herein, the user interface 804 may display a list comprising of all compared products, wherein the controller 802 may arrange the list in ascending order from the cheapest product to the most expensive product. The user interface 804 may also offer the option of re-ordering the list to the consumer, as per his preferences. The consumer may also be offered the option of changing the units of the volume being displayed to another suitable unit.

Referring to FIG. 9, which depicts a computing system, according to embodiments as disclosed herein. The computing system 702, as depicted, comprises of a networking interface 901, a comparator 902 and a database 903, in accordance with the present invention.

The networking interface 901 serves as the communication interface between the computing system 702 and handheld device 701. The networking interface 901 may be a wireless communication interface using at least one of Wi-Fi, cellular networks for communications.

The comparator 902 may be an app residing on the computing system 702, wherein the comparator 902 may be invoked by the computing system receiving information about a product. The information received may be in the form of a label scanned by the handheld device 701. In another embodiment herein, the information may be in the form of a label scanned by the handheld device 701 and the size and type of shape of the product corresponding to the scanned label. In another embodiment herein, the information may be in the form of a label scanned by the handheld device 701 and the volume of the product corresponding to the scanned label.

On receiving the information, the comparator 902 checks if the consumer wants to scan another product using the user interface 804. The comparator 902 may store the received information in the database 903 (wherein the database 903 may comprise of one or more memory modules). In certain embodiments herein, the database 903 may be present external to the computing system 702, wherein the computing system 702 communicates with the database 903 using a suitable network communication means such as a wired or wireless connection means.

If the consumer does not want to scan another product, the comparator 902 may ask the consumer to select at least two products for comparison using the user interface 804. The user interface 804 may offer a list of scanned products, wherein the consumer may select two or more products from the list for the comparison. At least one of the products may have been scanned by the handheld device 701 in real time. In certain embodiments, information related to at least one of the products may be retrieved from the database 503. In other embodiment herein, at least one of the products may be stored by another consumer in the database 903 and made available for access by other consumers.

The comparator 902 extracts the required information from the selected labels. The extracted information may comprise of cost of the product and so on. The comparator 902 further computes the volume of the product, wherein the comparator 902 may fetch the size and shape of the product 103 from a remote location or the database 903. In another embodiment herein, the comparator 902 may calculate the volume of the product 102 based on the shape and size of the product 102, as received from the handheld device 701. In another embodiment herein, the comparator 902 may receive the volume from the handheld device 701. The comparator 902 computes the cost per unit volume for each of the products. The comparator 902 further compares the cost per unit volume for all of the products and determines the cheapest product (wherein the cheapest product is the product with lowest cost per unit volume).

The comparator 902 sends the information to the handheld device 701 using the networking interface 501. The information may comprise of the cheapest product, the cost per unit volume of the cheapest product, a list of all the products that have been compared and corresponding costs per unit volume of the products.

FIG. 10 is a flowchart depicting the process of determining the cheapest product per unit volume, according to embodiments as disclosed herein. The consumer invokes 1002 the app residing on the handheld device 701. The app, on being invoked, determines 1004 the type of label 103 to be scanned. In certain embodiments herein, the check for the type of label 103 to be scanned may be done using a camera present on the handheld device 701, wherein the consumer may be instructed to point the camera at the label 103. In other embodiments herein, the app instructs the consumer to input the type of label 103 to be scanned. The consumer may be instructed to select from a list of labels, which are supported by the handheld device 701. In an alternative, the consumer may be instructed to enter the type of label 103 to be scanned, wherein an auto-completion or suggestion feature may be incorporated. If more than one type of scanner may be used to scan the label 103, the app may check for user preferences for the scanner to be used. The app may also check based on the past scanning history, as to which scanner has been used more frequently and which scanner gives better results, in terms of better clarity of scans, time required for scanning and so on. Based on the type of label, the app scans 1006 the product 102. The app may ask the consumer to point the scanning device in the direction of the label 103. The consumer may be given directions as to the proper manner in which the handheld device 701 has to be oriented. The app may use a suitable means such as a combination of a camera, an accelerometer and so on to detect the current orientation of the handheld device 701. In an embodiment herein, the app further captures the size and shape of the product. The app may instruct the consumer to use the camera to take pictures of the product at various angles, wherein the app may instruct the consumer as to the specific angles required to be used for taking the pictures. In another embodiment herein, the handheld device 401 may comprise of a 3-dimensional (3D) camera system, wherein the app may instruct the consumer to take a picture of the product from a specific angle. The app determines the type of shape of the product from the inputs received from the camera. Further, the app may determine the volume of the product, depending on the shape and size of the product. In another embodiment herein, the app determines the size and shape of the product using the 3D scanner. On receiving the product information, the app checks 1008 if the consumer wants to scan another product. The app may store the product information. If the consumer wants to scan another product, then the app performs the steps as disclosed above to scan a second product. If the consumer does not want to scan another label, the app sends 1010 the product information to the computing system 702. The product information may comprise of the scanned label placed on the product. In another embodiment herein, the product information may further comprise of the size of the product and the shape of the product. In another embodiment herein, the product information may comprise of the scanned label placed on the product, the volume of the product 103 as calculated by the handheld device 701. Further, the computing system 702 selects 1012 a plurality of products for comparison by asking the consumer for the same. The app may offer a list of scanned products, wherein the consumer may select two or more products from the list for the comparison. At least one of the products may have been scanned by the handheld device 701 in real time. In certain embodiments, at least one of the products may be retrieved from the database. The computing system 702 determines 1014 the cheapest product (wherein the cheapest product is the product with lowest cost per unit volume) by computing the cost per unit volume for each of the products to whom the label belongs and comparing the cost per unit volume for all of the products to whom the label belongs and determines the cheapest product. The computing system 702 sends 1016 the required information to the handheld device 701, where the app displays 1018 the cheapest product to the consumer. In certain embodiments herein, the app may display a list comprising of all compared products, wherein the app may arrange the list in ascending order from the cheapest product to the most expensive product. The app may also offer the option of re-ordering the list to the consumer, as per his preferences. The consumer may also be offered the option of changing the units of the volume being displayed to another suitable unit.

FIG. 11 depicts a handheld device scanning a label comprising a QR code, according to embodiments as disclosed herein. The handheld device 101 scans the label 103 using a QR code scanner. The scanner may be a camera-based scanner. The handheld device 101 decodes the QR code and extracts the price of the product. The handheld device 101 further fetches the size and shape of the product from a database of the retailer. Here, the shape of the product is a rectangular block, with length, depth and height being x, y and z respectively. The handheld device 101 computes the volume of the product as x*y*z. The handheld device 101 further determines the cost of the product (W) from the information present in the QR label and computes the cost per unit volume of the product as W/(x*y*z). The handheld device 101 may further process the information accordingly.

FIG. 12 depicts a handheld device scanning a label comprising a barcode, according to embodiments as disclosed herein. The handheld device 101 scans the label 103 using a barcode scanner. The scanner may be a camera based scanner or a laser scanner. The handheld device 101 further using a camera takes pictures of the product from a plurality of angles. The handheld device 101 determines the shape of the product and the size of the product based on the pictures. Here, the shape of the product is a rectangular block with the length, depth and height being a, b and c respectively. The handheld device 101 computes the volume of the product as a*b*c. The handheld device 101 further determines the cost of the product (D) from the information present in the barcode and computes the cost per unit volume of the product as D/(a*b*c). The handheld device 101 may further process the information accordingly.

FIG. 13 depicts a handheld device scanning a label with textual information, according to embodiments as disclosed herein. The handheld device 101 scans the label 103 using a suitable scanner such as a camera-based scanner. The handheld device 101 extracts the text from the image using a suitable Optical Character Recognition (OCR) technique and extracts the price of the product (P). The handheld device 101 further using a 3D camera takes pictures of the product from an appropriate angle. The handheld device 101 determines the shape of the product and the size of the product based on the picture. Here, the shape of the product is a cylindrical with the radius and height being r and h respectively. The handheld device 101 computes the volume of the product as π*r2*h. The handheld device 101 computes the cost per unit volume of the product as P/(π*r2*h). The handheld device 101 may further process the information accordingly.

FIG. 14 depicts a handheld device scanning a label with a RFID tag, according to embodiments as disclosed herein. The handheld device 101 scans the label 103 using a RFID scanner. The handheld device 101 decodes the RFID tag and extracts the price of the product (Q). The handheld device 101 further using a 3D scanner scans the product. The handheld device 101 determines the shape of the product and the size of the product based on the scanner output. Here, the shape of the product is a cylindrical with the radius and height being R and H respectively. The handheld device 101 computes the volume of the product as π*R2*H. The handheld device 101 computes the cost per unit volume of the product as Q/(π*R2*H). The handheld device 101 may further process the information accordingly.

The above examples disclose the shape of the product as a regular shape such as a rectangular block and a cylinder, however it may be obvious to a person of ordinary skill in the art to extend the embodiments as disclosed herein to irregular shapes, such as a merged rectangle and a sphere, a merged cube and a cylinder and so on.

The flowchart and block diagrams in the FIGS. 1, 2, 3, 4, 5, 6, 7, 8, 9 and 10 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figures. In certain embodiments, two blocks shown in succession may, in fact, be executed substantially concurrently, or the blocks may sometimes be executed in the reverse order, depending upon the functionality involved.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A computer implemented method for determining a cheapest product per unit volume, the method comprising:
receiving product identification from a plurality of labels belonging to a plurality of products into a handheld electronic device of a customer;
receiving, into the handheld electronic device, information related to a price of each of the plurality of products from the plurality of labels;
the handheld electronic device calculating a volume of each of the plurality of products based on shape and size of the products; and
the handheld electronic device determining the cheapest product per unit volume from the plurality of products based on the price of the products and volume of the products.

2. The method of claim 1, wherein the method more specifically comprises receiving product identification from a plurality of labels belonging to a plurality of products into a handheld electronic device of a customer while the customer is at a retail location.

3. The method of claim 1, wherein the method further comprises the handheld electronic device standardizing the units of size for each of the plurality of products before determining the volume of the products.

4. The method of claim 1, wherein calculating a volume of each of the plurality of products more specifically comprises:
the handheld electronic device capturing at least one of:
a picture of a product; and
a 3 dimensional scan of the product;
the handheld electronic device determining the shape and size of the product from the at least one of the picture and the 3 dimensional scan of the product; and
the handheld electronic device calculating the volume of the product.

5. The method of claim 1, wherein the method further comprises the handheld electronic device calculating a volume of a product by retrieving the size and shape of the product from product identification received from the product label.

6. The method of claim 1, wherein determining the cheapest product per unit volume more specifically comprises:
the handheld electronic device calculating a price per unit volume for each of the plurality of products based on the price of the product and volume of the product; and
comparing the product price per unit volume for each of the plurality of products.

7. The method of claim 1, wherein the method further comprises the handheld electronic device displaying a cheapest product per unit volume to the customer.

8. The method of claim 1, wherein the method further comprises displaying, via the handheld electronic device, a list comprising cost per unit volume information for each of the plurality of products to the customer.

9. A computer implemented method comprising:
optically capturing a first label from a first product via a customer handheld electronic device;
capturing an image of the first product via the handheld electronic device;
obtaining price information for the first product via the handheld electronic device;
determining a size and a shape of the first product from the image of the first product via the handheld electronic device;
calculating a volume of the first product from the size and shape of the first product via the handheld electronic device;
calculating a price per unit volume for the first product via the handheld electronic device; and
presenting to the customer the price per unit volume for the first product via the handheld electronic device.

10. The method of claim 9, wherein the method further comprises:
optically capturing a second label from a second product via a customer handheld electronic device;
capturing an image of the second product via the handheld electronic device;
obtaining price information for the second product via the handheld electronic device;
determining a size and a shape of the second product from the image of the second product via the handheld electronic device;
calculating a volume of the second product from the size and shape of the second product via the handheld electronic device;
calculating a price per unit volume for the second product via the handheld electronic device; and
presenting to the customer the price per unit volume for the second product via the handheld electronic device.

11. The method of claim 10, wherein the method further comprises displaying the first product and the second product in order of cheapest price per unit volume via the handheld electronic device.

12. The method of claim 9, wherein the method more specifically comprises optically capturing a first label from a first product via a customer handheld electronic device while the customer is at a retail location.

13. The method of claim 12, wherein the method more specifically comprises presenting to the customer the price per unit volume for the first product via the handheld electronic device while the customer is at the retail location.

14. The method of claim 9, wherein the method more specifically comprises obtaining price information for the first product from the first label via the handheld electronic device.

15. A computer system comprising:
a customer handheld electronic device scanner programmed to:
capture a first label from a first product; and
capture an image of the first product;
a comparator programmed to:
obtain price information for the first product;
determine a size and a shape of the first product from the image of the first product;
calculate a volume of the first product from the size and shape of the first product; and
calculate a price per unit volume for the first product; and
a customer handheld electronic device user interface programmed to:
present to the customer the price per unit volume for the first product.

16. The system of claim 15, wherein:
the customer handheld electronic device scanner is further programmed to:
capture a second label from a second product; and
capture an image of the second product via the handheld electronic device;
the comparator is further programmed to:
obtaining price information for the second product;
determine a size and a shape of the second product from the image of the second product;
calculate a volume of the second product from the size and shape of the second product; and
calculate a price per unit volume for the second product; and
the customer handheld electronic device user interface is further programmed to:
present to the customer the price per unit volume for the second product.

17. The system of claim 16, wherein the handheld electronic device user interface is further programmed to:
display the first product and the second product in order of cheapest price per unit volume.

18. The system of claim 15, wherein the customer handheld electronic device scanner is more specifically programmed to:
optically capture a first label from a first product while the customer is at a retail location.

19. The system of claim 18, wherein the customer handheld electronic device user interface is more specifically programmed to:
present to the customer the price per unit volume for the first product while the customer is at the retail location.

20. The system of claim 15, wherein the comparator is more specifically programmed to:
obtain price information for the first product from the first label.
